(19) United States
(12) Patent Application Publication
(10) Pub. No.: US 2024/0101351 A1
(43) Pub. Date: Mar. 28, 2024

(54) Material Handling Apparatus having Input/Output Station and Method of Use

(71) Applicant: OPEX Corporation, Moorestown, NJ (US)

(72) Inventor: Alexander Stevens, Moorestown, NJ (US)

(21) Appl. No.: 18/373,262

(22) Filed: Sep. 26, 2023

Related U.S. Application Data
(60) Provisional application No. 63/410,211, filed on Sep. 26, 2022.

(51) Int. Cl. B65G 1/137; B65G 1/04; B65G 47/64

(52) U.S. Cl. CPC B65G 1/1378; B65G 1/0492; B65G 47/64; B65G 37/02

(57) ABSTRACT

A transfer station for a material handling system is provided. The system may include a plurality of vehicles for retrieving items from a plurality of storage locations located in one or more racks. The transfer station is configured to accommodate the vehicles so that the vehicles drive into the transfer station and drive upwardly along a track in the transfer station. A transfer mechanism on the vehicle cooperates with a transfer mechanism on the transfer station to displace an item from the vehicle to a conveyor.

### RELATED APPLICATIONS

This application claims priority to U.S. Provisional Patent Application No. 63/410,211 filed on Sep. 26, 2022. The entire disclosure of the foregoing application is hereby incorporated herein by reference.

### Field of the Invention

The present invention relates to a material handling system for storing or retrieving items. More specifically, the present invention relates to a material handling system incorporating a plurality of destination areas and a plurality of vehicles for carrying items to and/or from the destination areas and to and/or from one or more workstations.

### BACKGROUND OF THE INVENTION

Storing and retrieving items to fill a customer order can be laborious and time consuming, especially in a system that stores thousands of items. Storing and retrieving items from thousands of storage areas requires significant labor to perform manually. In many fields, automated picking has developed to reduce labor cost and improve customer service by reducing the time it takes to fill a customer order. However, the known systems of automatically handling the materials are either very expensive or have limitations that hamper their effectiveness. Accordingly, there is a need in a variety of material handling applications for automatically storing and/or retrieving items.

### SUMMARY OF THE INVENTION

The present invention provides a number of inventive aspects that relate to material handling and/or storage and retrieval processes.

According to one aspect, a material handling system is provided, which includes a storage assembly housing a plurality of containers, a plurality of delivery vehicles, a transfer station and a first conveyor for conveying containers away from the transfer station.

The storage assembly may include a plurality of storage locations that may be vertically spaced apart from one another. For instance, the storage location may be arranged in a series of vertically spaced rows or a series of columns.

Optionally, the storage assembly may include a track positioned adjacent the storage locations.

The vehicles are configured to convey the containers and are configured to retrieve one of the containers from one of the storage locations. Similarly, the vehicles may be configured to store one of the containers into one of the storage locations.

The vehicles may include a drive system that is configured to drive the vehicle along the track to a first storage location so that the vehicle may retrieve a first of the containers.

Optionally, each vehicle may include a rechargeable power source for providing power to the drive system.

Each vehicle may include a surface configured to support one of the containers.

The system may include a central controller configured to control operation of each of the plurality of vehicle.

Optionally, the drive system of each vehicle includes one or more rotatable elements. For instance, the drive system may include a plurality of wheels or rollers.

The drive system may include a horizontal drive system and a vertical drive system.

Optionally, the horizontal drive system may be configured to drive the vehicle along a horizontal surface. The vertical drive system may be configured to drive the vehicle vertically along the track. For instance, the first storage location may be positioned above the horizontal surface and the vertical drive system may be configured to drive the vehicle upwardly toward the first storage location.

The system may include a workstation for retrieving items from the containers and the first conveyor may be configured to convey containers from the transfer station to the workstation.

The first horizontal conveyor may be configured to receive the containers and convey the containers along a first horizontal path to the workstation. Optionally, the first horizontal path is in a first direction.

Optionally, the first horizontal conveyor includes a loop comprising a first segment configured to displace the containers away from the transfer station and a second segment configured to displace the containers to the transfer station.

Optionally, the transfer station is configured to receive containers from the vehicles and convey the containers toward the first horizontal conveyor.

The transfer station may include a second horizontal conveyor configured to displace the containers along a second horizontal path toward the first horizontal conveyor. The second horizontal path may be transverse the first horizontal path.

The transfer station may also include a guide configured to guide the vehicles from the horizontal surface to a first transfer location positioned along the second horizontal conveyor. The system may be operable to transfer the first container from the first vehicle onto the second horizontal conveyor at the transfer location.

The transfer station may include one or more transfer locations vertically spaced apart from the first transfer location.

Optionally, the guide may include a first track for guiding the vehicles from the horizontal surface to one of the transfer locations.

The first track of the guide may include a first vertical track configured to cooperate with the drive system to drive the vehicle upwardly to one of the transfer locations.

The transfer station may include a third horizontal conveyor spaced apart from the second horizontal conveyor. The third horizontal conveyor may be operable to displace containers along a third horizontal path toward the first horizontal conveyor.

Optionally, the transfer station includes a second vertical track adjacent the third horizontal conveyor. The second vertical track may be cooperable with the drive system to drive the vehicle upwardly within an aisle between the second horizontal conveyor and the third horizontal conveyor.

Each vehicle may include a transfer mechanism configured to engage the containers. The transfer mechanism may be configured to transfer the containers between the vehicle and the storage locations.

Optionally, the transfer mechanism may be configured to transfer the first container from the first vehicle toward the second horizontal conveyor.

The transfer mechanism may be configured to displace the first container in a direction that is transverse the second horizontal path as the first vehicle displaces the container toward the second horizontal conveyor.

Optionally, the first horizontal conveyor includes a plurality of vertically spaced apart overlapping conveyors forming multiple conveyor levels.

Optionally, the second horizontal conveyor comprises a plurality of vertically spaced apart overlapping conveyors. If the first and second conveyors each include a plurality of overlapping conveyor level, then each level of the second conveyor may intersect one of the conveyor levels of the first horizontal conveyor.

According to yet another aspect, a method for storing or retrieving a plurality of containers is provided. The method uses a plurality of vehicles that move between storage locations where the containers are stored and a transfer station. The containers are transferred to the transfer station. From the transfer station, the containers are conveyed to a workstation. At the workstation an operator retrieves one or more items from the containers or stores one or more items into the containers.

Optionally, the method includes the step of controlling the plurality of vehicles by driving a first vehicle along a horizontal surface toward one of the storage racks. The first vehicle is then displaced upwardly from the horizontal surface to one of the storage locations to align the first vehicle with a first container.

The step of transferring the containers to the transfer station may include the step of driving the first vehicle with the first container along the horizontal surface between the storage rack and a transfer station.

Optionally, the first vehicle is displaced vertically between the horizontal surface and a transfer location at the transfer station.

The step of displacing the first vehicle vertically between the horizontal surface and a transfer location may include driving the first vehicle vertically up a guide adjacent the transfer location.

The step of transferring the first container may include the step of transferring the first container between the first vehicle and a first conveyor of the transfer station.

The step of transferring the container may include displacing the first container in a first direction toward the first conveyor.

Optionally, the first container may be conveyed along the first conveyor in a second direction that is transverse the first direction.

The method may include the step of transferring the container from the first conveyor to a second conveyor. The second conveyor may be operable to convey the first container to the workstation. The second conveyor may convey the first container in a third direction that is transverse the second direction.

Optionally, the step of conveying the first container includes conveying the first container along a conveyor loop extending away from the transfer station to the workstation. The step of conveying may also include the step of returning the first container along the loop to the transfer station.

Optionally, the first vehicle may be charged during the step of displacing the first vehicle vertically between the horizontal surface and the transfer location

The step of transferring the first container between the first vehicle and a first conveyor may include displacing the first container onto a transfer mechanism. The transfer mechanism may be operable between a first position in which the transfer mechanism is disposed in a lowered position below the first conveyor and a second position in which the transfer mechanism is disposed above the first conveyor.

Optionally, the first container may be displaced onto the transfer mechanism while the transfer mechanism is in the first position.

The step of displacing the transfer mechanism into the second position may displace the transfer mechanism into engagement with the first container.

The method may include the step of actuating the transfer mechanism to displace the first container across the first conveyor.

After the step of actuating the transfer mechanism the transfer mechanism may be lowered into the first position.

Optionally, the first container may be conveyed away from the transfer location after the step of lowering the transfer mechanism into the first position.

The first vehicle may include a transfer assembly operable to transfer containers onto or off of the vehicle and the step of transferring the first container between the first vehicle and a first conveyor may include actuating the transfer assembly.

### BRIEF DESCRIPTION OF THE DRAWINGS

The foregoing summary and the following detailed description of the preferred embodiments of the present invention will be best understood when read in conjunction with the appended drawings, in which:

FIG. 1 is a diagrammatic plan view of a material handling system;

FIG. 2 is an enlarged plan view of a portion of the material handling system illustrated in FIG. 1;

FIG. 3 is a side elevational view of a portion of the material handling system illustrated in FIG. 1;

FIG. 4 is an enlarged perspective view of a transfer station of the material handling system illustrated in FIG. 1;

FIG. 5 is a perspective view of a vehicle for use with the material handling system illustrated in FIG. 1;

FIG. 6 is an end view of the vehicle illustrated in FIG. 5; and

FIG. 7 is a side elevational view of the vehicle illustrated in FIG. 5.

### DETAILED DESCRIPTION OF THE INVENTION

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

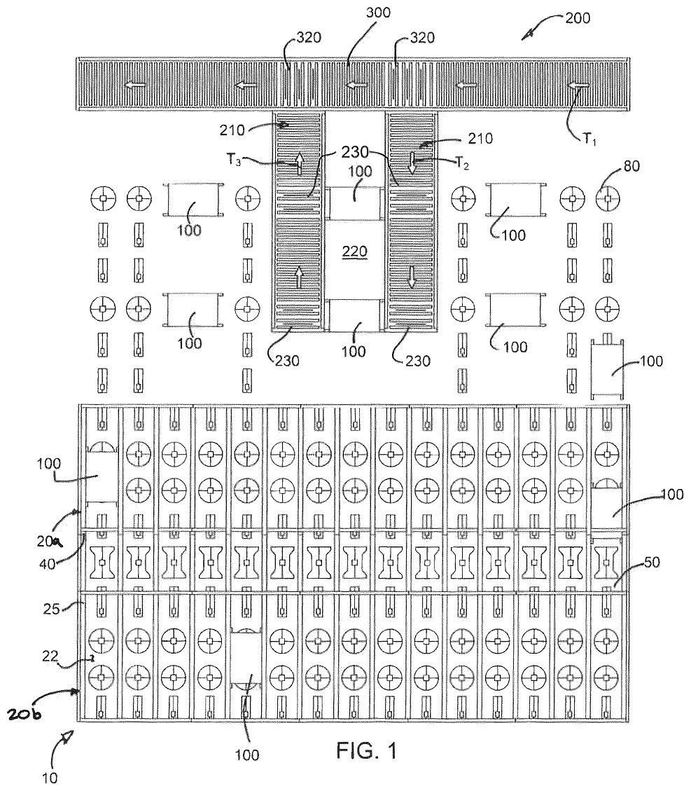

Referring now to the figures in general and to FIG. 1 specifically, an apparatus for sorting or retrieving items is designated generally 10. The apparatus 10 includes one or more mechanisms for retrieving items from one of a plurality of locations, such as storage areas 25 located in racks 20. The retrieval mechanism may include one or more vehicles that retrieve items from the storage locations and deliver the items to a transfer station 200 where the items can be transferred to an alternate material handling system, such as a conveyor system. Additionally, or alternately, items can be transferred onto the vehicles at the transfer station so that the vehicles can deliver items from the transfer station 200 to the racks 20. In this way, the system 10 may include a mechanism for continuously storing items to and retrieving items from the various storage areas.

It should be understood that various items and subassemblies of the overall system can be used alone or in combination with material handling systems having different structure or operation to the system illustrated in the Figures and described below.

The material handling system 10 may include any of a variety of different systems for storing items. For instance, the material handling system may include a system that incorporates a plurality of autonomous vehicles such as the system described in U.S. Pat. No. 11,254,504. The entire description of U.S. Pat. No. 11,254,504 is hereby incorporated herein by reference.

As illustrated in FIG. 1, the material handling system 10 may optionally incorporate one or more racks 20. Each rack may include a plurality of storage locations 25. Optionally, the storage locations may be arranged into one or more vertical columns 22. For instance, FIG. 1 illustrates a plurality of racks 20 and each rack may include a plurality of columns 22, each of which includes a plurality of storage locations 25.

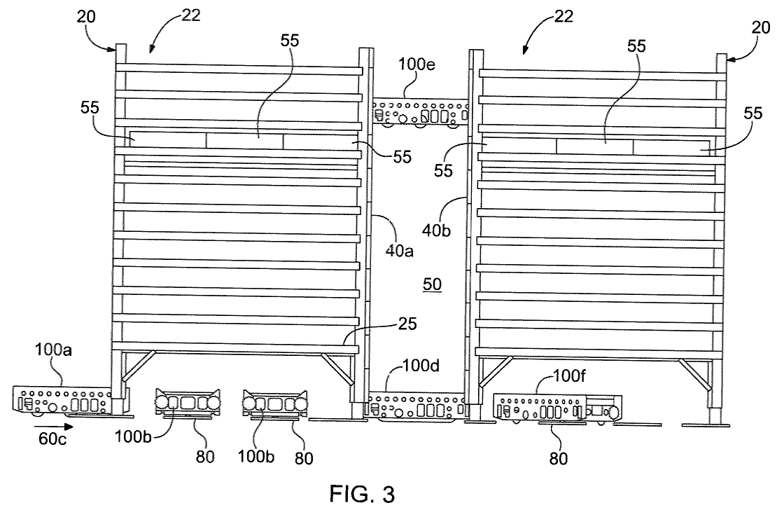

The items that are handled by the system may be stored directly in the storage locations. Alternatively, the items may be stored in bins or totes 55 and the storage locations 25 may be configured to store the totes 55 as shown in FIG. 3. Accordingly, it should be understood that unless stated otherwise in the following description, when a tote is mentioned, the term tote is broad enough to include a container for containing one or more items as well as simply being an item that is not necessarily contained in a container.

Referring again to FIG. 1, the system may include a plurality of racks 20 that optionally may be positioned to form rows or aisles 50. For instance, a first rack 20a may be spaced apart from a second rack 20b so that an aisle 50 is formed between the two racks. In particular, the first rack 20a may be substantially parallel to the second rack 20b to form an aisle having a substantially uniform width. Additionally, the system may include a plurality of racks forming a plurality of aisles 50. The aisles 50 may be aligned as a series of parallel rows. However, it should be understood that if the system incorporates a plurality of racks 20, the racks may be arranged in a variety of configurations and if the system includes a plurality of aisles 50, the aisles need not be parallel.

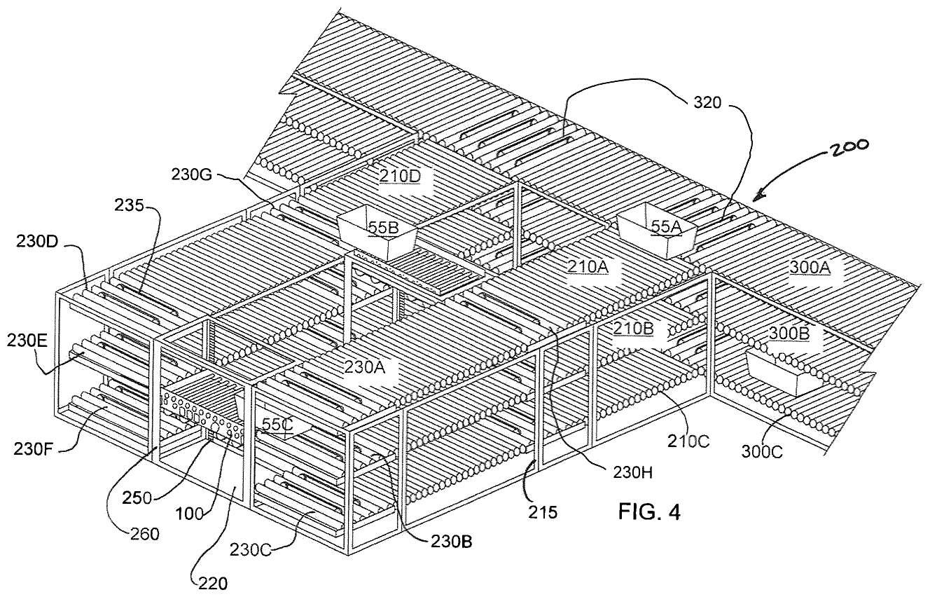

Optionally, the system includes an automated element for storing and retrieving totes from the storage locations. One such automated element is an autonomous vehicle. For example, as discussed further below, the automated element may include a plurality of autonomous vehicles 100. Additionally, the automated vehicles 100 may be configured to transport the totes 55 to a workstation where one or more items may be removed from a tote on one of the vehicles 100. In one embodiment, a human operator or automated mechanism may remove an item from the vehicle. Alternatively, as shown in FIGS. 1 and 4, the tote 55 may be transferred to a conveyor system at a transfer station 200.

The system 10 and/or various components of the system may be controlled by a central controller 90, such as a microcomputer. The central computer may receive signals from various elements, such as sensors and control various aspects of the system based on signals received from the various components. The central controller may also store data regarding the location of various items to be retrieved from the system. Additionally, the central controller may include data regarding the identification of items to be retrieved, such as a number of items to fill customer orders, as well as the quantity of such items. In this way, the central controller may control and coordinate the operation of various elements to schedule the retrieval and processing of a variety of items from the storage locations.

### Rack System

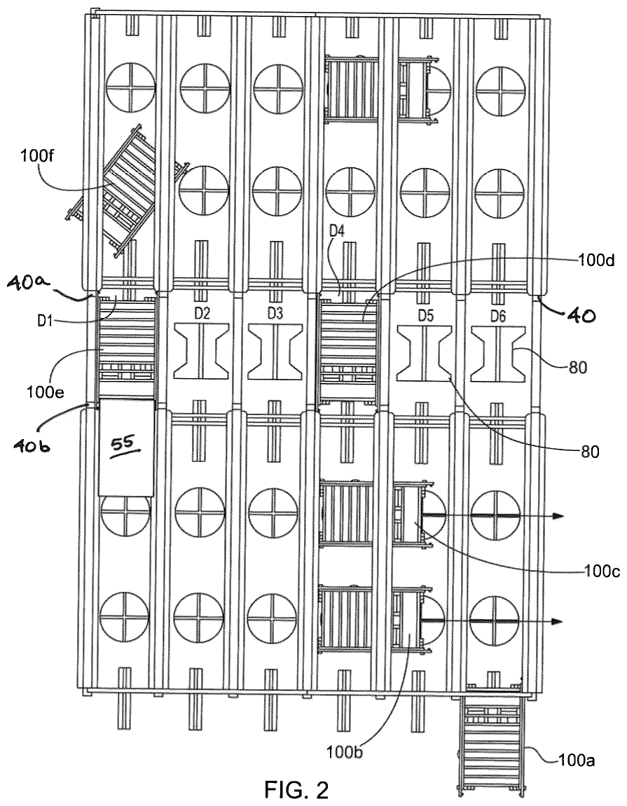

As noted above, the system may include one or more racks 20 having a plurality of storage locations 25. The details of an exemplary storage rack 20 is illustrated in FIGS. 1 and 2. However, it should be noted that the system may include any of a variety of elements for organizing a plurality of storage locations 25.

Referring to FIGS. 2-3, each rack may include a plurality of support legs that extend substantially vertically and a plurality of brackets that extend substantially horizontally interconnecting the support legs. The brackets may be planar elements forming shelves so that the shelves form storage locations 25. However, in the embodiment illustrated in FIG. 2, the horizontal brackets are L-shaped brackets that form horizontal ledges to support edges of the totes 55. The horizontal brackets may be spaced apart from one another up the height of the vertical legs to form a column 22 of vertically spaced apart storage locations 25.

As discussed above, the system may include a plurality of racks that are spaced apart to form one or more aisle 50. Optionally, referring to FIGS. 1&3, a track 40 may be positioned along one or more of the racks and the track may be configured to guide vehicles 100 vertically so that the vehicles may be conveyed up and down the column 22 to the storage locations in the column. Additionally, it may be desirable to position a first track along a rack on one side of the aisle, such as along rack 20a and a second track along a rack on the opposite side of the aisle, such as along rack 20b. The vehicles 100 may be configured so that the vehicle travels in the aisle 50 traveling vertically along a track on rack 20a while simultaneously travelling vertically along a track on rack 20b.

If the system utilizes one or more vehicles and one or more racks, the racks may be configured to allow the vehicles to travel under the racks 20 as well as being able to travel across or along any aisles that may be incorporated into the system. Referring to FIG. 2, the vehicles may follow a path that moves along one or more segments that may be parallel or transverse to the aisle. For instance, a first vehicle 100a is oriented for horizontal movement along a path transverse the length of aisle 50. A second vehicle 100b is oriented for horizontal movement under the rack along a path that is parallel to the length of the aisle 50. Additionally, a third vehicle 100d is positioned within the aisle 50 to climb vertical tracks along the racks 20 on either side of the aisle. A fourth vehicle 100e is also positioned within the aisle and has climbed up the track 40a,b to a storage location 25 in an upper portion of the column 22. Finally, a fifth vehicle 100f is positioned under the rack 20 and is oriented at an intermediate position between the orientation of vehicle 100a and the orientation of vehicle 100b. In particular, the racks may be configured to facilitate the vehicles turning horizontally underneath the racks. The fifth vehicle 100f illustrates the vehicle in the process of turning under the rack from a first path to a second path.

### Vehicles

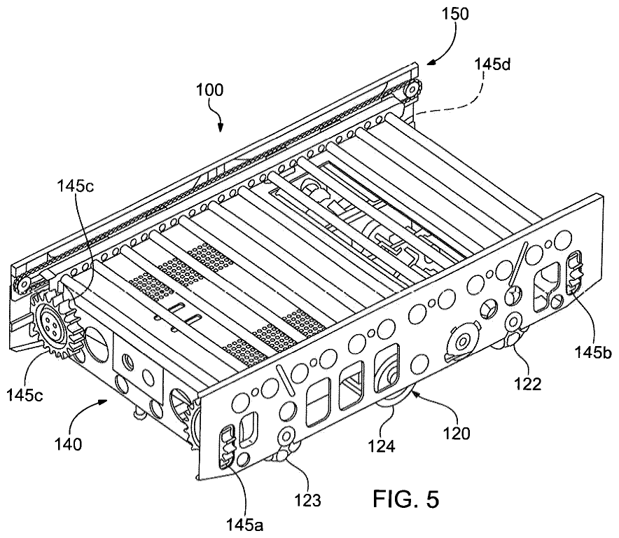

FIGS. 5-7 illustrate details of one of the vehicles 100 that are shown in FIGS. 1-4. As noted above, if the system incorporates vehicles, the structure of the vehicle may vary. The details of an exemplary delivery vehicle 100 are disclosed in U.S. Pat. No. 11,254,504. The details of the disclosure of U.S. Pat. No. 11,254,504 are hereby incorporated herein by reference. However, it should be understood that each of the vehicle's features described in U.S. Pat. No. 11,254,504 or discussed below are optional features that may be varied or eliminated depending on the application.

The vehicles 100 may be autonomous systems that include an onboard power supply for driving the vehicle. The vehicles may also include a communication system for wirelessly receiving and transmitting control signals between each vehicle and a control element, such as a central controller. In this way, the vehicle may receive control signals regarding the location for retrieving an item and the location to which the vehicle is to deliver the item.

The central controller may include any of a variety of control mechanisms, including but not limited to a central processing unit, such as a microprocessor. Aspects of the controller may be embodied in hardware and/or in software (including firmware, resident software, micro-code, and the like), which may be generally referred to herein as a “circuit” or “module”. Furthermore, aspects of the present invention may take the form of a computer program product on a computer-usable or computer-readable storage medium having computer-usable or computer-readable program code embodied in the medium for use by or in connection with an instruction execution system. In the context of this description, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object oriented programming language, such as Java.RTM, Smalltalk or C++, and the like. However, the computer program code for carrying out operations of embodiments of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The vehicle illustrated in FIG. 3 includes a horizontal drive assembly 120 for driving the vehicle 100 in a horizontal direction. The horizontal drive 120 may be configured to drive the vehicle along a track or along an open horizontal surface, such as a floor. For instance, one option for a horizontal drive includes a plurality of rotatable elements, such as wheels or rollers. One or more drive mechanisms may be provided for turning the rotatable elements. Additionally, the rotatable elements may turn from side to side to steer the vehicle.

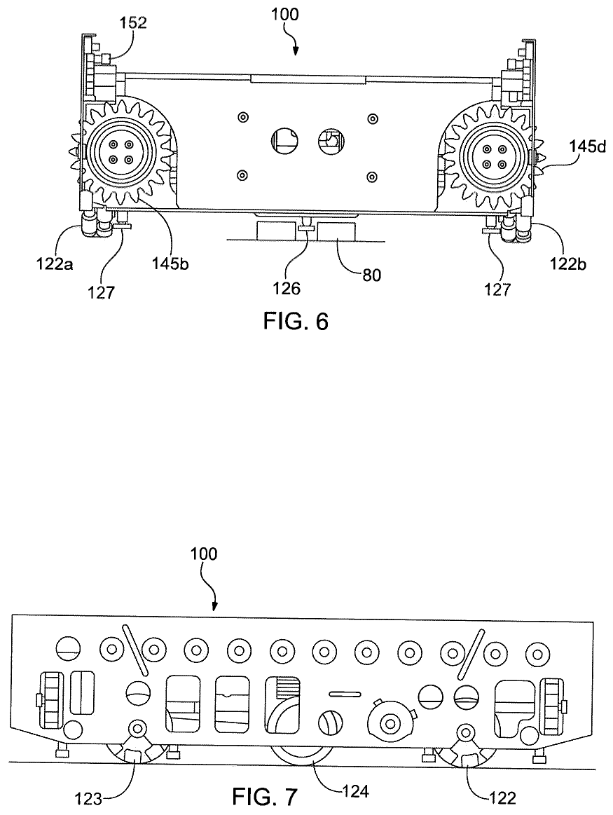

Alternatively, as illustrated in FIGS. 5-7, the vehicle may have a horizontal drive 120 formed of a plurality of rollers 122, 123, 124 that are rotatable around a first axis, such as around an axle. Additionally, the rollers 122, 123, 124 may be constrained to rotation about a single axis. For example, in the embodiment illustrated in FIGS. 5-7, the horizontal drive 120 includes a pair of central rollers 124 and first and second sets of outer rollers 122, 123. The first set 122 is positioned forwardly of the central rollers while the second set of rollers 123 is positioned rearwardly of the central rollers 124. The outer rollers 122, 123 may include rollers spaced apart along the length of a horizontal axle so that each set of outer rollers includes a first roller 122a on one side of the vehicle and a second roller 122b on an opposite side of the vehicle as shown in FIG. 6. Additionally, as shown in FIG. 6, each set of outer rollers may include a pair of rollers 122b on each side of the vehicle.

As noted above, the vehicle 100 may have any of a variety of steering mechanisms for controlling the direction of travel of the vehicle. For example, an optional steering mechanism is a zero-turn mechanism that can turn the vehicle without substantially moving forwardly. Optionally, the zero-turn mechanism provides a means for turning the vehicle about a vertical axis extending through the vehicle.

The zero-turn mechanism comprises a linkage that allows the wheels or rollers on one side of the vehicle to rotate at a different speed than the wheels or rollers on the opposing side of the vehicle. Optionally, the linkage allows the wheels or rollers on one side of the vehicle to rotate in different directions than the wheels or rollers on the opposing side of the vehicle. In this way, by varying the speed and/or rotational direction of the wheels on one side of the vehicle relative to the speed and/or rotational direction of the wheels on the opposing side of the vehicle, the zero-turn mechanism changes the direction of travel to steer the vehicle. Optionally, the system may also include one or more guides 80 to guide or align the vehicles as they travel and the vehicles may include a guide element that cooperates with the guides to align and or guide the vehicles.

In addition to the horizontal drive mechanism 120 the vehicle may also include a vertical drive mechanism 140 for driving the vehicle 100 vertically within the rack 20. In particular, as noted above, the system may include a guide mechanism such as a track 40 that is disposed adjacent the rack 20. The vertical drive mechanism 140 may be configured to cooperate with the vertical guide mechanism 40 to drive the vehicle 100 vertically.

FIGS. 5-6 illustrate an exemplary vertical drive 140 that includes a plurality of rotatable gears 145, however, it should be understood that the vertical drive 140 may include any of a number of drive mechanisms for driving the vehicle vertically. Referring to FIG. 5, the vertical drive may include drive gear 145 that rotates about a horizontal axis that is transverse the horizontal axis of rotation of the horizontal drive mechanism 120. In particular, optionally, the vehicle includes a pair of drive gears 145 that are spaced apart from one another so that teeth of a first one of the gears 145b project outwardly from a first side of the vehicle and teeth of a second one of the gears 145d project outwardly from a second side of the vehicle as shown in FIG. 6. These first and second gears 145b,d may be synchronously driven. Additionally, as shown in FIG. 5, the vehicle may include two pairs of vertical drive elements that are spaced apart from one another along the length of the vehicle. In particular, optionally, the vehicle includes a first pair of vertical drive elements 145a,c at a first end of the vehicle and a second pair of vertical drive elements 145b,d at a second end of the vehicle.

Referring to FIGS. 1-3, the rack 20 may be configured so that the track 40a on one rack is spaced apart from the track 40b on a second rack a distance corresponding to the spacing between the first set of vertical drive elements 145a and the second set of drive elements 145b. In this way, the first vertical drive element 145a may cooperate with the first track 40a to drive the vehicle up the first track 40a, while the second vertical drive element 145b may cooperate with the second track 40b to drive the vehicle up the second track 40b. Optionally, the two vertical drive elements 145a,b are synchronously driven so that the vehicle maintains a horizontal orientation as the vehicle moves from horizontal movement to vertical movement.

The vertical drive 140 may optionally be configured so that vertical drive has a width that remains substantially constant as the vehicle transitions from horizontal movement to vertical movement. In this way, the vertical drive 140 need not telescope of extend outwardly to transition from horizontal driving to vertical driving. For example, referring to FIGS. 5-6 forward climbing gears 145b and 145d each have a horizontal axis of rotation and the spacing between the horizontal axis of rotation of drive member 145b is fixed relative to the horizontal axis of rotation of drive member 145d while the vehicle is moving horizontally and while the vehicle is climbing.

The vehicle may also include an optional transfer mechanism for transferring items between the vehicle and a destination, such as a storage location. The transfer mechanism 150 may be operative to transfer an item between a platform surface of the vehicle and one of the plurality of destination areas 25. As shown in FIG. 5, the platform surface is optionally defined by the exterior surfaces of a plurality of rollers.

The transfer mechanism 150 may be any of a variety of mechanisms for loading items onto the vehicle and for unloading items from the vehicle into one of the storage areas. Additionally, the transfer mechanism 150 may be specifically tailored for a particular application. In the present instance, the transfer mechanism 150 comprises one or more displaceable element(s) configured to engage an item stored at a storage location and pull the item onto the vehicle. More specifically, in the present instance, the vehicle includes one or more displaceable element(s) configured to move toward a tote in a storage location and releasably engage the tote. After the displaceable element(s) engage the tote, each displaceable element is displaced away from the storage location, thereby pulling the tote onto the vehicle 100.

The displaceable element of the transfer mechanism may any of a variety of items, such as a bar, rod, or another element configured to engage an item, for example, a tote. For example, referring to FIGS. 5-6, the transfer mechanism 150 may include one or more displaceable pins 152. Additionally, the transfer mechanism may include a drive element for displacing the pins 152. For instance, optionally, the transfer mechanism 150 includes two drive elements in the form of endless carriers such as a drive belt or drive chain 154. Optionally, each pin 152 projects or extends inwardly toward the longitudinal center line of the vehicle. The transfer mechanism is preferable configured to cooperate one of the totes to releasably engage the tote. For example, in the present instance, the pins 152 are configured to mate with a recess on the tote so that the transfer mechanism can engage the tote. However, it should be recognized that the transfer mechanism may include any of a variety of elements for engaging items to be transferred onto of off of the vehicle.

### Input/Output Station

Referring to FIGS. 1 and 4, the system includes an input/output station for loading containers onto vehicles 100 or for unloading containers from vehicles. For instance, containers may be loaded onto vehicles to replenish the stock of items that are stored in the rack system. In such an application, a conveyor system 300 may automatically convey the containers 55 to the input/output station 200 where the containers are loaded onto vehicles 100. The vehicles 100 then deliver the containers 55 to the racks 20 and transfer the containers into the storage locations 25. Alternatively, the vehicles 100 may retrieve containers 55 from the storage locations in the racks 20 and deliver the containers to the input/output station 200 where the containers are transferred onto the input/out station 200. The containers 55 are then automatically conveyed away by a conveyor system 300 so that the containers may be processed in a downstream process. For instance, at a downstream station an operator may retrieve one or more items from the container 55.

Optionally, the conveyor system 300 may include one or more conveying systems that form a loop so that containers 55 may be conveyed away from the transfer station input/output station 200 and subsequently conveyed back to the input/output station 200. In this way, the conveyor system 300 may include one or more forward segments that convey containers 55 away from the input/output station 200 and one or more return segments that convey containers toward the input/output station 200. The downstream stations discussed above may be positioned along either the forward or return segments.

The input/output station 200 includes one or more transfer station 230 where containers are transferred between the input/output station 200 and the vehicles. In the embodiment illustrated in FIGS. 1 and 4, the system includes multiple loading stations 230. For instance, the input/output station 200 may include a pair of spaced apart conveyor assemblies 210 and each conveyor assembly may include one or more transfer station 230. In the present instance, each conveyor 210 includes a plurality of transfer stations.

The input/output station 200 may incorporate a single transfer conveyor 210; however, in the present instance the station 200 includes a pair of conveyors. The transfer conveyors may be configured in a variety of configurations. For instance, the conveyors may be disposed at an angle to one another. Alternatively, in the illustrated embodiment, the transfer conveyors 210 are spaced apart by a gap and substantially parallel to one another. The gap formed between the conveyors 210 may form an aisle 220 in which the delivery vehicles 100 operate as discussed further below.

Referring to FIG. 4, each transfer conveyor 210 may include multiple stacked conveyors. For example, as illustrated, each transfer conveyor includes a plurality of levels in which each level is a separate conveyor that overlies the level below. For instance, the transfer conveyor on one side of the aisle 220 may includes three levels, designated 210A, 210B and 210C. Similarly, the primary conveyor 300 may include multiple levels 300A, 300B and 300C in which each level aligns with one of the corresponding levels from each transfer conveyor, such as conveyors 210A, 2106 and 210C. Although the primary conveyor 300 and the transfer conveyors 210 are illustrated as having three levels, it should be understood that the primary conveyors and transfer conveyors can have any number of levels depending on the application.

Referring to FIG. 1, each transfer conveyor 210 may include a plurality of loading stations 230 spaced apart along the length of the transfer conveyor. For instance, each transfer conveyor 210 may include two loading stations 230. Additionally, as shown in FIG. 4, each level of the transfer conveyor 210A, 210B or 210 C may have multiple loading stations. For instance, conveyor 210A may include transfer stations 230A and 230H. In this way, each transfer conveyor 230 may have a plurality of overlapping transfer stations, such as 230A, 230B and 230C or 230D, 230E and 230F.

As discussed above, each delivery vehicle 100 may include a transfer mechanism 150 operable to transfer items, such as totes 55, onto the transfer conveyors 210 at the loading stations 230. Additionally, as shown in FIGS. 1 and 4, the loading stations 230 may include a loading mechanism 235 that is operable to load the item onto the transfer conveyor 210. Specifically, the loading mechanism 235 is configured to displace items in a direction that is transverse the direction of travel of items on the transfer conveyor. For instance, as shown in FIG. 1, the transfer conveyor 210 may be operable in a first direction to move items in a first direction designated T₂. Similarly, the transfer conveyor may be operable in a reverse direction to move items in a reverse direction designated T₃ in FIG. 1. The loading mechanism 235 may be configured to load items onto the transfer conveyor by displacing the items transverse directions T₂ or T₃. For example, the loading mechanism 235 may displace items in a direction parallel to T₁.

The loading mechanism 235 may be any of a variety of items for conveying items across a conveyor. For instance, the loading mechanism may be a right angle transfer assembly. Specifically, the loading mechanism 235 may be one or more conveyors belts entrained about a plurality of rollers or pulleys. The conveyors belts may be elongated in a direction opposite of the direction of travel T₂, T₃.

The loading mechanism 235 may be displaceable between a first and second position so that in a first position the loading mechanism hidden or otherwise out of the path of movement of transfer conveyor 210. In this way, in the first position the loading mechanism does not impede movement along the transfer conveyor, such as along the length of the conveyor (e.g. direction T₂ or T₃). In a second position, the loading mechanism may impede movement along the length of the conveyor.

By way of example, the loading mechanism 235 may be a conveyor that is disposed between rollers of the transfer conveyor. The loading mechanism may be displaceable between first and second positions. In the first position, the loading mechanism 235 may be positioned below the top surface of the rollers of the transfer conveyor 210 so that items, such as totes 55 may freely move along the length of the transfer conveyor either toward the primary conveyor 300 or toward one of the loading stations 230 (i.e. direction T₂ or T₃). In the second position, the loading mechanism may be positioned upwardly so that the top surface of the loading mechanism is raised above the transfer conveyor 210. In this way, the loading mechanism 235 may impede displacement of items along the length of the transfer conveyor 210. Additionally, in the raised position, the loading mechanism is operable to displace items onto the transfer conveyor so that the items can be displaced by the transfer conveyor 210.

Although the loading mechanism has been described as being a right angle conveyor having a raised position in which the loading mechanism is operable and a lowered position in which the loading position is stowed or retracted, it should be understood that the transfer mechanism may be any of a variety of mechanisms for displacing an item along the width of a conveyor.

### Charging Assembly

The transfer station 200 may optionally include a charging mechanism for charging the vehicle 100. The charging mechanism may be connected with an electrical power source to provide a charging current to re-charge the power supply of the vehicles. For instance, optionally each vehicle includes an onboard rechargeable power source. The rechargeable power source may be a rechargeable battery. However, in the present instance, the vehicles comprise a power source that includes a plurality of ultracapacitors that can be rapidly re-charged. For example, the power source may include a plurality of supercapacitors or ultracapacitors sufficient to power the vehicle as it moves horizontally or vertically with a payload of 30-40 kilograms.

The charging mechanism may be any of a variety of elements for providing a charging current to the vehicle. For instance, in the present instance, the charging mechanism may be a charging rail that cooperates with electrical contacts on the vehicle 100.

The charging rail may comprise one or more elongated electrically conductive elements. The rail may form one or more channel or groove configured to cooperate with electrical contacts of the vehicle. For instance, the vehicle may include one or more charging contacts, such as brushes. The brushes may project outwardly from the vehicle. The brushes are oriented and configured to mate or cooperate with the charging rail. For example, the charging rail may be horizontally oriented and the charging rails may project horizontally outwardly from the rear side of the vehicle so that the brushes project into electrical contact with the charging rail when the vehicle is in the carriage.

### Operation

The system 10 and the various subassemblies described above may be configured to facilitate numerous methods of operations related to material handling as described below.

The system 10 may include a plurality of autonomous vehicles 100 for delivering items to transfer stations 230. The vehicles may be configured to drive along a horizontal pathway 60, such as driving along the ground. Optionally, the vehicles may drive along the ground to a storage area where a plurality of items are stored. For instance, a plurality of items may be stored in a plurality of containers, such as totes. Optionally, the totes may be stored in a plurality of racks 20 that are spaced apart forming longitudinally elongated aisles 50. The aisles may be parallel with one another.

The vehicles 100 may drive under one of the racks 20 in a direction parallel to one of the aisles 50. The vehicle 100 may drive under the rack until the vehicle reaches a destination column 22 in the rack, which is the column in which an item is to be stored or from which an item is to be retrieved.

Optionally, when the vehicle arrives at the destination column the vehicle may rotate or turn to change the direction of travel. For instance, while the vehicle is in the destination column, the vehicle may change from a direction of travel parallel to the aisle to a direction of travel transverse the aisle. Alternatively, the vehicle may drive under the rack 20 to the destination column along a path that is substantially perpendicular to the aisle. After reaching the destination column, the vehicle optionally drives perpendicular to the aisle into the aisle of the destination column.

In the aisle, the vehicle 100 optionally drives upwardly to the destination location 25 where the item is to be stored or from which the item is to be retrieved. The vehicle 100 may be raised up the column 22 by an elevator or other mechanism. However, in the present instance, the vehicle includes a vertical drive mechanism 140 operable to drive the vehicle upwardly. Additionally, the system may include a track or guide 40 positioned adjacent the column and the vertical drive 140 of the vehicle may engage the track or guide to drive the vehicle up the column to the destination location.

Once the vehicle is raised to the destination location, an item, such as a tote 55, may be transferred between the vehicle and the destination location. For instance, the vehicle may include a transfer mechanism for transferring totes and the vehicle may actuate the transfer mechanism to transfer a tote from the vehicle to the destination location or to transfer a tote from the destination location to the vehicle.

After transferring an item between the vehicle and the destination location, the vehicle optionally drives downwardly to a horizontal path, such as the ground. The vehicle may then drive horizontally along a path that is perpendicular to the aisle.

The system may also include one or more transfer stations 200. The system may include a method for operating an autonomous vehicle at a workstation 200. For instance, the vehicle 100 may travel along a horizontal path carrying an item, such as a tote 55, to the transfer station 200. The vehicle may drive to the transfer station to align the vehicle with a pre-determined location within the transfer station.

The system may optionally include a method for controlling the vehicle to transfer items, such as totes, at the transfer station 200. For instance, the method may include the step of driving the vehicle 100 into the transfer station 200 and raising the vehicle upwardly. For instance, the vehicle may be raised upwardly toward a transfer conveyor 210. Optionally, the input/output station 200 may include a one or more transfer stations 230 and the method may include the step of raising the vehicle so that a tote on the vehicle is positioned at the transfer stations 230.

Optionally, the steps of raising the vehicle 100 may include the step of driving the vehicle up a track 250. The track may include a first pair of spaced apart track segments and a second pair of spaced apart rear track segments. The method may include the step of driving the rearward edge of the vehicle up the rear track segments and the forward edge of the vehicle up the forward track segments. For instance, as shown in FIG. 4, the vertical tracks 250 may be positioned adjacent the transfer stations 230. The pair of rear tracks may be disposed on one side of the aisle adjacent the sides of loading stations 230D, 230E and 230F and the pair of forward tracks may be disposed on the other side of the aisle adjacent loading stations 230A, 230B and 230C. In this way, the delivery vehicle may move vertically within the aisle to align the delivery vehicle with one of the loading stations.

Optionally, the step of driving the vehicle 100 up a track 250 may include the step of rotating vertical drive gears 145 of the vehicle about axes that are transverse the axes of rotation of a plurality of drive elements that drive the vehicle along a horizontal surface. The step of driving the vehicle up the track may optionally include the step of driving the vertical drive gears in a first direction to drive up the track 250. Driving the vertical gears in a first direction drives the vertical drive gears up the track.

The method may also include the step of transferring an item between the delivery vehicle 100 and the loading station 230 after the vehicle is aligned with the loading station. The step of transferring may include the step of operating a transfer mechanism on the delivery vehicle to move an item between the vehicle and the loading station 230. Alternatively, or additionally, the step of transferring may include the step of actuating a transfer mechanism of the input/output station. For instance, the step of transferring may include the step of driving a transfer mechanism of the delivery vehicle to displace a container 55 from the vehicle toward the loading station 230. Once part of the container 55 is loaded onto the loading station, the loading mechanism 235 may displace the container across the width of the transfer conveyor 210 to load the container onto the transfer conveyor. Similarly, the method may include the step of loading a container 55 onto the delivery vehicle by operating a loading mechanism to displace the container across the width of the conveyor toward the delivery vehicle. The transfer mechanism 150 of the vehicle is then operated to load the container onto the delivery vehicle.

The step of operating a loading mechanism 235 may include the step of raising the loading mechanism above the top surface of the transfer conveyor.

Although the step of transferring a container between the delivery vehicle and the transfer conveyor may include both the steps of operating a transfer mechanism 150 on the delivery vehicle and operating a loading mechanism 235, it should be understood that the method is not limited to utilizing both a transfer mechanism on the delivery vehicle and a separate loading mechanism on the input/output station. Instead, the transfer mechanism 150 on the delivery vehicle may be configured to displace the container 55 across the width of the transfer conveyor. Alternatively, the loading mechanism 235 may be configured to engage the containers so that the loading mechanism can transfer containers onto the delivery vehicles or off of the delivery vehicles without operating a transfer mechanism on the delivery vehicle.

As illustrated in FIGS. 1 and 4, the method may include the step of transferring items between a primary conveyor 300 configured to displace items in a first direction, such as T1 and a transfer conveyor 210 configured to displace items in a second direction, such as T2 or T3, that is transverse T1. The step of transferring items between the primary conveyor 300 and the transfer conveyor 210 may include the step of operating a right-angle transfer mechanism 320. The right-angle transfer mechanism 320 may be an assembly configured similarly to the loading mechanism 235 described above.

As noted above, the method may include the step of transferring a container between the input/output station 200 and a primary conveyor 300. For instance, the step of transferring a container may include the step of conveying a container along a first path at the input/output station toward the primary conveyor 300. The method may include the step of operating a right-angle transfer mechanism to displace the container onto the primary container.

The method may optionally include the step of conveying the container away from the input/output station 200. For instance, the method may include the step of conveying the container along one or more conveyor segments away from the input/output station. Optionally, the method may include the step of conveying the container toward the input/output station 200 after the step of conveying the container along one or more conveyor segments away from the input/output station 200. In this way, the method may include the step of conveying the container along a loop leading away from the input/output station and returning back to the input/output station. The method may also include the step of conveying the container to a workstation along the loop so that an operator may load an item into the container or remove an item from the container.

The system may optionally include a method for charging autonomous material handling vehicles. The method may include the step of driving a vehicle 100 to an input/output station 200 to deliver an item. The vehicle may include an electrical contact and the input/output stations may include a charging element for providing a charging current. The method may include the step of electrically connecting the electrical contact of the vehicle with the charging element. For instance, the step of connecting may include the step of biasing the charging element toward the charging contact and/or the step of biasing the charging contact toward the charging element.

Additionally, the method of connecting may include the step of driving the vehicle toward the charging element to drive the electrical contact into electrical connection with the charging element. Optionally, the method includes the step of automatically adjusting the height of the charging element relative to the charging contact as the charging contact is displaced into electrical engagement with the charging element. Additionally, the method may include the step of automatically adjusting the lateral positioning of the charging contact relative to the charging element as the charging contact is displaced into electrical engagement with the charging element.

The method of charging the vehicle may optionally include the step of raising the vehicle vertically while continuing to charge the vehicle. For instance, the method may include the step of maintaining electrical engagement between an electrical contact of the vehicle with a charging element while the vehicle is displaced upwardly. Further, a charging current may be continuously provided to the charging element as the vehicle is displaced upwardly at the input/output station 200. Additionally, the charging current to the charging element may be maintained as the vehicle remains at a loading station 230 so that a charging current may be supplied to the vehicle while an transfer mechanism transfers items to or from the vehicle. The charging current may also be supplied to the vehicle while the vehicle is lowered downwardly. The method may optionally include the step of disengaging the vehicle from the charging element by driving the vehicle away from the charging element.

It should therefore be understood that this invention is not limited to the particular embodiments described herein but is intended to include all changes and modifications that are within the scope and spirit of the invention as set forth in the claims.

What is claimed is:

1. A material handling system, comprising:
a plurality of storage locations vertically spaced apart from one another;
a track positioned adjacent the storage locations;
a plurality of containers positioned in the storage locations;
a plurality of vehicles configured to convey the containers, wherein each vehicle is operable to retrieve one of the plurality of containers from one of the storage locations or to store one of the plurality of container into one of the storage locations, wherein each vehicle comprises:
a drive system configured to drive the vehicle along the track to a first of the storage locations to position the vehicle to retrieve a first of the containers from the first storage location; and
a power source for providing power to the drive system;
a first horizontal conveyor configured to receive the containers and convey the containers along a first horizontal path to a workstation where an operator can retrieve one or more items from the containers wherein the first horizontal path is in a first direction;
a transfer station configured to receive containers from the vehicles and convey the containers toward the first horizontal conveyor wherein the transfer station comprises:
a second horizontal conveyor configured to displace the containers along a second horizontal path toward the first horizontal conveyor, wherein the second horizontal path is transverse the first horizontal path; and
a guide configured to guide the vehicles from the horizontal surface to a first transfer location positioned along the second horizontal conveyor, wherein the system is operable to transfer the first container from the first vehicle onto the second horizontal conveyor at the transfer location.

2. The system of claim 1 wherein the storage locations are arranged in a series of columns or vertically spaced apart rows.

3. The system of claim 1 comprising one or more transfer locations vertically spaced apart from the first transfer location.

4. The system of claim 3 wherein the guide comprises a first track for guiding the vehicles from the horizontal surface to one of the transfer locations.

5. The system of claim 4 wherein the first track of the guide comprises a first vertical track configured to cooperate with the drive system to drive the vehicle upwardly to one of the transfer locations.

6. The system of claim 1 wherein the transfer station comprises a third horizontal conveyor spaced apart from the second horizontal conveyor forming an aisle between the second and third horizontal conveyors, wherein the third horizontal conveyor is configured to displace containers along a third horizontal path toward the first horizontal conveyor.

7. The system of claim 6 wherein the transfer station comprises a second vertical track adjacent the third horizontal conveyor wherein the second vertical track is cooperable with the drive system to drive the vehicle upwardly within the aisle between the second horizontal conveyor and the third horizontal conveyor.

8. The system of claim 1 wherein each vehicle comprises a transfer mechanism configured to engage the containers, wherein the transfer mechanism is configured to transfer the containers between the vehicle and the storage locations.

9. The system of claim 8 wherein the transfer mechanism is configured to transfer the first container from the first vehicle toward the second horizontal conveyor.

10. The system of claim 9 wherein the transfer mechanism is configured to displace the first container in a direction that is transverse the second horizontal path as the first vehicle displaces the container toward the second horizontal conveyor.

11. The system of claim 1 wherein the first horizontal conveyor comprises a plurality of vertically spaced apart overlapping conveyors forming multiple conveyor levels and the second horizontal conveyor comprises a plurality of vertically spaced apart overlapping conveyors each of which intersects one of the conveyor levels of the first horizontal conveyor.

12. The system of claim 1 wherein the drive system comprises one or more rotatable wheel or roller.

13. The system of claim 1 wherein the drive system comprises a horizontal drive system and a vertical drive system wherein the horizontal drive system is configured to drive the vehicle along a horizontal surface and wherein the vertical drive system is configured to drive the vehicle vertically along the track, wherein the first storage location is positioned above the horizontal surface and the vertical drive system is configured to drive the vehicle upwardly toward the first storage location.

14. The system of claim1 wherein the first horizontal conveyor comprises a loop comprising a first segment configured to displace the containers away from the transfer station and a second segment configured to displace the containers to the transfer station.

15. A method for storing or retrieving a plurality of containers in a plurality of storage locations in one or more storage racks, comprising the steps of:
controlling a plurality of independently operable vehicles to deliver containers to the storage locations or retrieve containers from the storage locations, wherein the step of controlling comprises the steps of;
driving a first of the vehicles along a horizontal surface toward one of the storage racks;
displacing the first vehicle upwardly from the horizontal surface to one of the storage locations to align the first vehicle with a first of the containers;
driving the first vehicle with the first container along the horizontal surface between the storage rack and a transfer station;
displacing the first vehicle vertically between the horizontal surface and a transfer location at the transfer station;
transferring the first container between the first vehicle and a first conveyor of the transfer station;
controlling the first conveyor to convey the first container away from the transfer location toward a workstation or from the workstation and toward the transfer location;
retrieving one or more items from the first container at the workstation or storing one or more items into the first container at the workstation.

16. The method of claim 15 wherein the step of displacing the first vehicle vertically between the horizontal surface and a transfer location comprises the step of driving the first vehicle vertically up a guide adjacent the transfer location.

17. The method of claim 16 wherein the step of transferring the container comprises displacing the first container in a first direction toward the first conveyor.

18. The method of claim 17 wherein the step of controlling the conveyor comprises conveying the first container along the first conveyor in a second direction that is transverse the first direction.

19. The method of claim 18 comprising the step of transferring the container from the first conveyor to a second conveyor operable to convey the first container to the workstation, wherein the second conveyor conveys the first container in a third direction that is transverse the second direction.

20. The method of claim 15 wherein the step of conveying the first container comprises the steps of:
conveying the first container along a conveyor loop extending away from the transfer station to the workstation; and
returning the first container along the loop to the transfer station.

21. The method of claim 15 comprising the step of charging the first vehicle during the step of displacing the first vehicle vertically between the horizontal surface and a transfer location

22. The method of claim 15 wherein the step of transferring the first container between the first vehicle and a first conveyor comprises displacing the first container onto a transfer mechanism operable between a first position in which the transfer mechanism is disposed in a lowered position below the first conveyor and a second position in which the transfer mechanism is disposed above the first conveyor.

23. The method of claim 22 wherein the step of displacing the first container onto a transfer mechanism comprises displacing the first container onto the transfer mechanism while the transfer mechanism is in the first position.

24. The method of claim 23 comprising the step of displacing the transfer mechanism into the second position which displaces the transfer mechanism into engagement with the first container.

25. The method of claim 24 comprising the step of actuating the transfer mechanism to displace the first container across the first conveyor.

26. The method of claim 25 comprising the step of lowering the transfer mechanism after the step of actuating the transfer mechanism.
